(19) United States
(12) Patent Application Publication
(10) Pub. No.: US 2009/0002168 A1
(43) Pub. Date: Jan. 1, 2009

(54) WIRELESS TAG READER/WRITER DEVICE AND SIGNAL TRANSMISSION/RECEPTION METHOD THEREOF

(75) Inventor: Shuji Oozawa, Mishima-shi (JP)

Correspondence Address: AMIN, TUROCY & CALVIN, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/042,589

(22) Filed: Mar. 5, 2008

(30) Foreign Application Priority Data
Jun. 26, 2007 (JP) 2007-167664

(51) Int. Cl. G08B 13/22

(52) U.S. Cl. 340/572.1

(57) ABSTRACT

A wireless tag reader/writer device of one example of the present invention sends question signals to a plurality of wireless tags at once and receives response signals sent from the wireless tags. The wireless tag reader/writer device sends transmission signals for a plurality of times by changing a transmission power of question signals sent out to the plurality of wireless tags, and obtains the response signals from the wireless tags every time the transmission power is changed.

### CROSS-REFERENCE TO RELATED APPLICATION

This application is based upon and claims the benefit of priority from prior Japanese Patent Application No. 2007-167664, filed Jun. 26, 2007, the entire contents of which are incorporated herein by reference.

### BACKGROUND OF THE INVENTION

1. Field of the Invention

The present invention relates to a wireless tag reader/writer device that communicates with a wireless tag, and a signal transmission/reception method thereof.

2. Description of the Related Art

A wireless tag (RFID: Radio Frequency Identification) relating to the present invention includes at least a memory and an antenna, and is a chip-shaped responder that communicates (exchanges a signal) with an external interrogator via an antenna connected to the interrogator.

In recent years, a wireless tag system, in which the wireless tag is adhered to a predetermined object and information of the wireless tag is read out by a wireless tag reader/writer (hereinafter referred to as the reader/writer device) that exchanges a signal with the wireless tag, has rapidly become widely used.

However, objects to which the wireless tags are adhered are normally collected at one place in a manner such as being stacked. Although the reader/writer device needs to communicate with a number of such wireless tags simultaneously, transmission and reception of a signal between the reader/writer device and each of the wireless tags are not necessarily in excellent conditions at all times.

In addition, a reception characteristic of the wireless tag is somewhat varied at the beginning, and a rate of succeeding in responding fluctuates depending on a reception power. When the wireless tag is used for a long period of time, the wireless tag is often damaged in a distribution process, or the characteristic of the wireless tag often changes due to aged deterioration.

In view of the above, even when question signals are sent with a predetermined power, all the wireless tags do not necessarily receive the question signals in a most excellent state. Also, the wireless tags do not send response signals without receiving the question signals. Accordingly, a variety of contrivances have been made so that many of the wireless tags receive the question signals and many of such wireless tags send corresponding response signals.

For example, in Jpn. Pat. Appln. Laid-Open Publication No. 2001-34720, a reception antenna of a reader/writer device is sequentially switched to receive a signal from each wireless tag. In addition, in Jpn. Pat. Appln. Laid-Open Publication No. 05-128319, a capacity or a resistance of a resonant circuit of an information card that sends and receives a signal to and from a reader/writer is changed to change a reception state.

However, the reader/writer device described in Jpn. Pat. Appln. Laid-Open Publication No. 2001-34720 requires a plurality of antennas and is large in size. In addition, the system described in Jpn. Pat. Appln. Laid-Open Publication No. 05-128319 has a problem that the information card becomes complicated and expensive.

### SUMMARY OF THE INVENTION

According to the present invention, a wireless tag reader/writer device that is capable of receiving response signals from many of wireless tags since many of wireless tags can receive question signals and being reduced in size, and a signal transmission/reception method of the wireless tag reader/writer device can be provided.

According to an aspect of the present invention, there is provided a wireless tag reader/writer device that sends question signals to a plurality of wireless tags at once and receives response signals sent from the wireless tags, the device sending transmission signals for a plurality of times by changing a transmission power of the question signals to be sent to the plurality of wireless tags, and acquiring the response signals from the wireless tags each time the transmission power is changed.

According to an aspect of the present invention, there is provided a signal transmission/reception method of a wireless tag reader/writer device, the signal transmission/reception method that generates question signals, sends the question signals at once from a transmission/reception antenna with a predetermined transmission power to a plurality of wireless tags attached to a plurality of objects, receives response signals by the transmission/reception antenna from the wireless tags that receive the sent question signals and generates and sends the response signals, electrically processes the received response signals, and changes the transmission power after receiving the response signals, comprising: sending the identical question signals from the transmission/reception antenna by changing a transmission power, and receiving response signals from the wireless tags with respect to the question signals sent with each of predetermined transmission powers by the transmission/reception antenna.

According to an aspect of the present invention, there are provided a small-size wireless tag reader/writer device that is capable of receiving response signals from many of wireless tags since many of wireless tags can receive question signals, and a signal transmission/reception method of the wireless tag reader/writer device.

### BRIEF DESCRIPTION OF THE DRAWINGS

FIG. 1 is a view showing a configuration of a wireless tag reader/writer device according to an embodiment of the present invention;

FIG. 2 is a view showing a configuration example of a transmission power control unit 18 according to the embodiment of the present invention shown in FIG. 1;

FIG. 3 is a view showing a flowchart for explaining operation according to the embodiment of the present invention; and

FIG. 4 is a view showing a timing for explaining the operation according to the embodiment of the present invention.

### DETAILED DESCRIPTION OF THE PREFERRED EMBODIMENTS

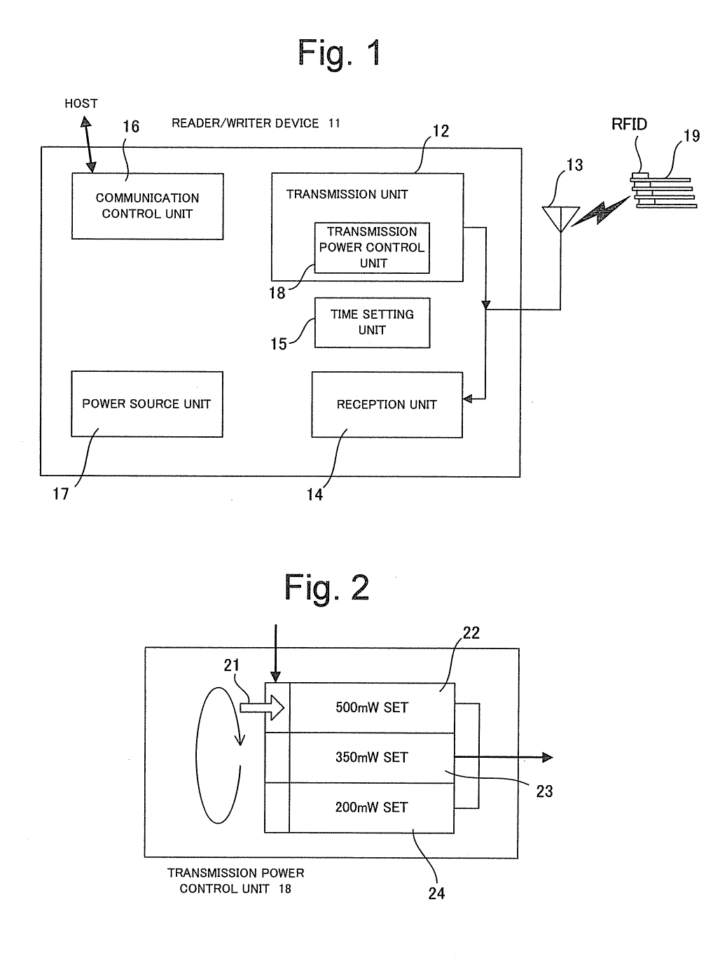

Hereinafter, an embodiment of the present invention will be described with reference to the accompanying drawings. FIG. 1 shows an entire configuration of a reader/writer according to an embodiment of the present invention that communicates with a wireless tag.

In FIG. 1, a reader/writer device 11 includes a transmission unit 12 that generates question data and outputs a question signal obtained by modulating the generated question data, a transmission/reception antenna 13 that sends the question signal output from the transmission unit 12 to a wireless tag (RFID) and receives a response signal from the wireless tag, a reception unit 14 that demodulates and processes the response signal received from the transmission/reception antenna to obtain response data, a time setting unit 15 that sets a period of time until receiving the response signal after sending the question signal, a communication control unit 16 that exchanges data of the reception unit 14 and the transmission unit 12 with a host computer, and a power source unit 17 that supplies power to the transmission unit 12, the reception unit 14, the communication control unit 16, and the like.

The transmission unit 12 is provided with a transmission power control unit 18 which will be described later. As shown in FIG. 2, the transmission power control unit 18 switches an output power of the input question signal, for example, among three powers including 500 mW 22, 350 mW 23, and 200 mW 24 by a pointer 21 cyclically.

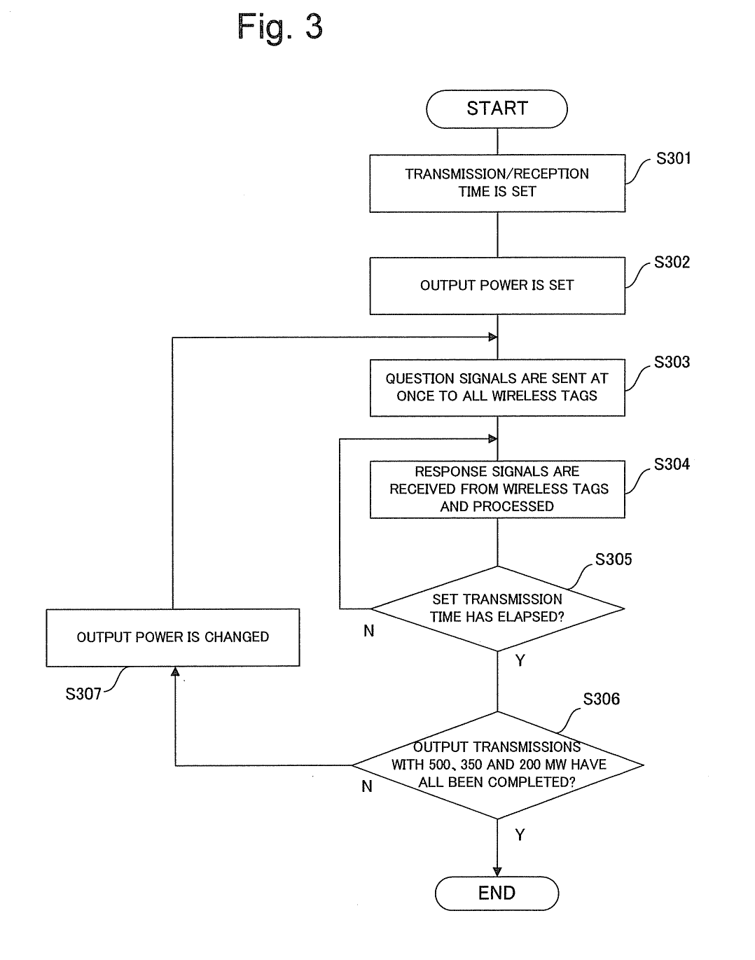

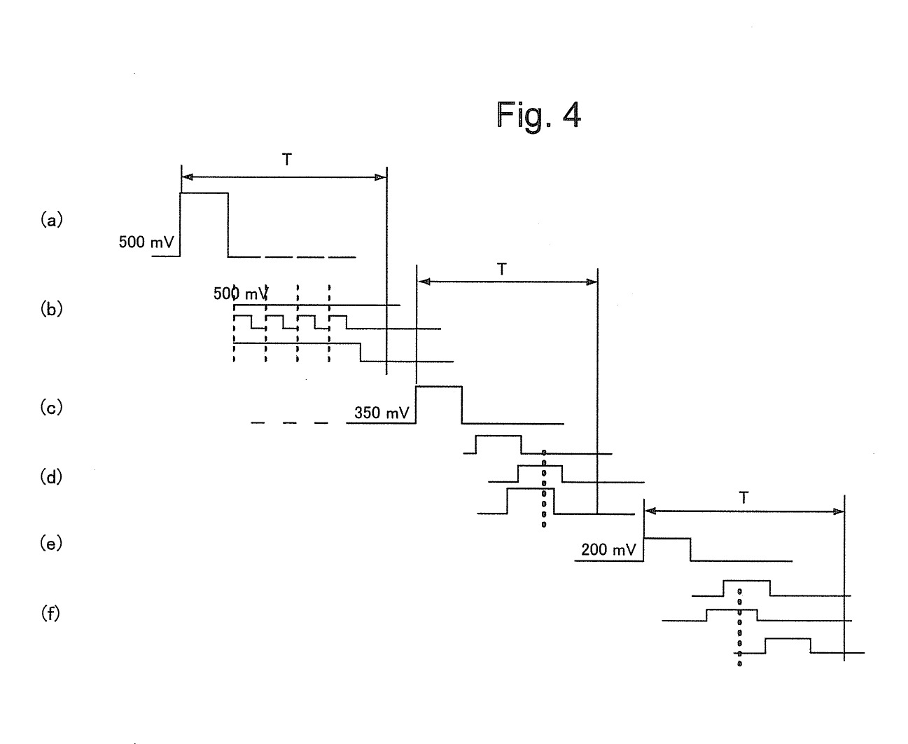

Operation of the reader/writer device 11 in the present embodiment will be described by using a flowchart shown in FIG. 3 and a timing chart shown in FIG. 4.

When the operation of the reader/writer device 11 starts, in step S301, the time setting unit 15 first sets transmission/reception time T from transmission that outputs the question signal with a certain power until reception of the response signal. Then, in the next step S302, an output power is set to any of 500 mW, 350 mW, and 200 mW, and for example, to 500 mW to begin with.

Then, in step S303, the question signals generated by modulating the question data are sent at once to stacked objects consisting of, for example, envelopes 19 each having a wireless tag adhered thereto.

FIG. 4 is a chart showing timings at which the reader/writer device sends the question signal and the wireless tag sends the response signal. FIG. 4(a) shows a timing at which the transmission power control unit 18 controls the question signal generated in the transmission unit 12 of the reader/writer device 11 to send the question signal with 500 mW from the transmission/reception antenna 13. With respect to the sent question signal, each of the wireless tags adhered to the envelops 19 receives and demodulates the question signal from the reader/writer device 11 to generate response data. Then, the response data is modulated to obtain the response signal.

As shown in FIG. 4(b), the response signal is sent from the wireless tag to the reader/writer device 11 together with own ID code. In actuality, the response signal is not sent from all the wireless tags adhered to the stacked envelopes 19. There is a case where the wireless tag does not send the response signal appropriately with respect to the question signal from the reader/writer device 11, due to a relative positional relationship between the reader/writer device 11 and the wireless tag, or intensity of a radio wave.

In the next step S304 shown in FIG. 3, the reader/writer device 11 receives and electrically processes the response signal from each of the wireless tags to demodulate the response signal to obtain the response data. Then, in step S305, whether a predetermined period of time (transmission/reception time T) set in the time setting unit 15 in step S301 has elapsed or not is checked. Until the set predetermined period of time elapses, the operation returns to step S304 and the reader/writer device 11 continues to receive the response signal from the wireless tags.

In step S305, whether the transmission/reception time T set in advance has elapsed or not is checked. In step S306, whether transmission of the question signal with the transmission powers of 500 mW, 350 mW, and 200 mW has been completed or not is checked. In this case, since the transmission of the questions signal with 500 mW has not been completed yet, the operation moves to step S307, and the transmission power control unit 18 of the reader/writer device 11 changes the transmission power to 350 mW, for example.

Then, in the next step S303, as shown in FIG. 4(c), the question signal same as the question signal sent with 500 mW previously is sent with the transmission power 350 mW from the transmission/reception antenna 13 this time.

In the next step S304, as similar with the case of sending the question signal with 500 mW as described above, the reader/writer device 11 receives the response signal from the wireless tags adhered to the stacked envelopes as shown in FIG. 4(d). Then, in step S305, whether the transmission/reception time T has elapsed or not is checked. After the time T has elapsed, the operation moves to step S306 and whether the transmission of the question signal with the three types of transmission powers has been completed or not is checked.

In this case, the transmission of the question signal with 200 mW has not been completed. Therefore, the operation moves to step S307, and the setting of the output power in the transmission power control unit 18 is changed to 200 mW. Then, in a timing shown in FIG. 4(e), the question signal is sent from the transmission/reception antenna 13 to the wireless tags again.

In step S304, the reader/writer device 11 receives and processes the response signal from each of the wireless tags with respect to the question signal sent with the transmission power of 200 mW in a timing shown in FIG. 4(f). Then, in step S305, whether the transmission/reception time T has elapsed or not is checked.

In the next step S306, whether the transmission of the question signal with all the three types of transmission powers has been completed or not is checked. In this case, the transmission of the question signal with the three types of the transmission powers has been completed, and therefore all processing is terminated.

As described above, the same question signal is sent three times with different transmission powers, and therefore, each of the wireless tags receives the question signal for three times at the most. However, depending on the intensity of the transmission power, each of the wireless tags may not be able to receive the question signal. There is a case where the question signal is received for two times out of three times, or the question signal is received only once.

In case the wireless tag cannot receive the question signal for three times out of three times of transmission, the reader/writer device cannot receive the response signal corresponding to the question signal. However, if the wireless tag can receive the question signal at least once out of three times, the response signal corresponding to the question signal can be sent to the reader/writer device 11.

A conventional reader/writer device sends the question signal only once with a certain transmission power. Accordingly, there exist many wireless tags which cannot receive the question signal, and such wireless tags do not send the response signal, and therefore the reader/writer device has been unable to receive the response signal from many of the wireless tags. However, in the present embodiment of the present invention, the reader/writer device sends the question signal with different transmission powers for three times and receives the response signal from each of the wireless tags. Therefore, if the wireless tag can receive the question signal for at least once out of three times, the wireless tag sends the corresponding response signal. Accordingly, the reader/writer device can receive the response signal from more of the wireless tags than the conventional case.

If the wireless tag is assumed to receive the question signal twice out of three times in the above embodiment, the wireless tag sends the response signal twice. The reader/writer device receives the response signals twice and processes an excellent one of such response signals as the response signal from the wireless tag. In order to select the response signal as a reference, a variety of methods may be used based on a certain response signal selecting standard, such as setting the response signal having the highest reception signal level among the received reception signals in a certain period of time as a reference.

As the response signal selection standard, the response signal received first among the response signals having a certain reception level or higher can be adopted. For example, in the embodiment described above, the configuration may be such that, when the response signal having a predetermined reception level or higher is received at the time the question signal is sent with the reader/writer transmission power of 500 mW, such response signal is set as a reference, and even if, after the above, the response signal is received from the same wireless tag when the transmission signal is sent with 350 mW, such response signal is set to be not adopted.

If a state of receiving the response signal of the reader/writer device is excellent at all times, the response signal received first may be adopted as the response signal from the wireless tag. Alternatively, the wireless tag can be configured in a manner that, after receiving the question signal and sending the corresponding response signal, the wireless tag does not send the corresponding response signal even if the wireless tag receives the same question signal in a short period of time.

In the embodiment described above, the description was made with respect to a case where the output power is switched in the order of 500 mW, 350 mW, and 200 mW. However, the present invention is not limited to the above output powers and to the above order of magnitudes of the transmission powers.

In the embodiment described above, the description was made with respect to a case where the output power is switched among three types of powers of 500 mW, 350 mW, and 200 mW. However, the present invention is not limited thereto, and the output power may be switched among four or more types of powers, or may be switched only for twice.

In the embodiment described above, the description was made with respect to a case where a transmission/reception shared antenna is used for the antenna. However, separate antennas may be used for transmission and reception. The wireless tag reader/writer device according to the present invention only needs to have a function to send the question signal to the wireless tag and receive the response signal sent from the wireless tag, and does not necessarily have a function of writing in the wireless tag.

The present invention is not limited to the above embodiment, and may be embodied with a variety of modifications within the scope of the present invention.

What is claimed is:

1. A wireless tag reader/writer device that sends question signals to a plurality of wireless tags at once and receives response signals sent from the wireless tags, the device comprising:
sending transmission signals for a plurality of times by changing a transmission power of the question signals to be sent to the plurality of wireless tags, and acquiring the response signals from the wireless tags each time the transmission power is changed.

2. A wireless tag reader/writer device, comprising:
a question signal generating unit that generates question signals to be sent at once to a plurality of wireless tags attached to a plurality of objects;
a transmission/reception antenna that sends the question signals generated by the question signal generating unit and receives response signals from wireless tags that receive the sent question signals to generate and send response signals;
a response signal receiving unit that electrically processes the response signals received by the transmission/reception antenna; and
a transmission power changing unit that changes a transmission power for sending the question signals by the transmission/reception antenna.

3. The wireless tag reader/writer device according to claim 2, wherein
the transmission power changing unit changes the transmission power for a plurality of times, and receives the response signals sent from the wireless tags each time the transmission power is changed with respect to the question signals sent from the transmission/reception antenna with the changed transmission powers.

4. The wireless tag reader/writer device according to claim 3, wherein
the transmission power changing unit changes a predetermined transmission power after a predetermined period of time elapses since the transmission/reception antenna sends the question signals with the transmission power.

5. The wireless tag reader/writer device according to claim 3, wherein
the transmission power changing unit changes the transmission power for three times or more, sends the identical question signals from the transmission/reception antenna, and when the response signal receiving unit obtains a plurality of the response signals from the same wireless tag, selects one of the plurality of the response signals in accordance with a predetermined response signal selecting standard.

6. The wireless tag reader/writer device according to claim 5, wherein
the response signal selecting standard adopts a response signal having a highest reception level among a plurality of response signals received by the wireless tag reader/writer device with respect to question signals with different transmission powers.

7. The wireless tag reader/writer device according to claim 5, wherein
the response signal selecting standard adopts a response signal received first temporally among a plurality of response signals having a predetermined reception level or higher received by the wireless tag reader/writer device with respect to question signals with different transmission powers.

8. A wireless tag reader/writer device, comprising:
a transmission unit that includes a transmission power control unit that generates question signals by modulating question data sent to a plurality of wireless tags attached to a plurality of objects, and controls a transmission power for sending out the question signals;
a transmission/reception antenna that sends at once the questions signals generated in the transmission unit and receives response signals generated in and sent from the wireless tags that receive the question signals; and
a reception unit that carries out signal processing by receiving the response signals received by the transmission/reception antenna, wherein
the transmission power control unit changes a transmission power for sending the questions signals for a plurality of times, and the reception unit carries out receiving processing of the identical question signals sent from each of the changed transmission powers.

9. The wireless tag reader/writer device according to claim 8, wherein
a time setting unit that determines time of changing an output power is further included in the transmission power control unit.

10. A signal transmission/reception method of a wireless tag reader/writer device, the signal transmission/reception method that generates question signals, sends the question signals at once from a transmission/reception antenna with a predetermined transmission power to a plurality of wireless tags attached to a plurality of objects, receives response signals by the transmission/reception antenna from the wireless tags that receive the sent question signals and generate and send the response signals, electrically processes the received response signals, and changes the transmission power after receiving the response signals, the method comprising:
sending the identical question signals from the transmission/reception antenna by changing a transmission power, and receiving response signals from the wireless tags with respect to the question signals sent with each of predetermined transmission powers by the transmission/reception antenna.

11. A signal transmission/reception method of a wireless tag reader/writer device, the signal transmission/reception method that generates question signals, sends the question signals at once from a transmission/reception antenna with a predetermined transmission power to a plurality of wireless tags attached to a plurality of objects, receives response signals by the transmission/reception antenna from the wireless tags that receive the sent question signals and generate and send the response signals, electrically processes the received response signals, and changes the transmission power after receiving the response signals, the method comprising:
sending the identical question signals from the transmission/reception antenna by changing a transmission power, and receiving response signals from the wireless tags with respect to the question signals sent with each of predetermined transmission powers by the transmission/reception antenna; and
selecting one response signal by a predetermined response signal selecting standard, in case a plurality of response signals are received from an identical wireless tag with respect to the question signals with different transmission powers.

12. The signal transmission/reception method in the wireless tag reader/writer device according to claim 11, wherein
the response signal selecting standard adopts a response signal having a highest reception level among a plurality of response signals received by the wireless tag reader/writer device with respect to question signals with different transmission powers.

13. The signal transmission/reception method in the wireless tag reader/writer device according to claim 11, wherein
the response signal selecting standard adopts a response signal received first temporally among a plurality of response signals having a predetermined reception level or higher received by the wireless tag reader/writer device with respect to question signals with different transmission powers.
